(19) United States
(12) Patent Application Publication
(10) Pub. No.: US 2010/0082697 A1
(43) Pub. Date: Apr. 1, 2010

(54) DATA MODEL ENRICHMENT AND CLASSIFICATION USING MULTI-MODEL APPROACH

(76) Inventors: Narain Gupta, Secunderabad (IN); Sachin Sharad Pawar, Navi Mumbai (IN); Girish Joshi, Mumbai (IN)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/243,951

(22) Filed: Oct. 1, 2008

(51) Int. Cl. G06F 17/30

(52) U.S. Cl. 707/802; 707/E17.046

(57) ABSTRACT

The present invention provides a method and system for classifying data items using enriched data models, and more particularly using multiple number of small sized data models for achieving higher percentage of classification. The present invention is particularly directed to data model building and classification technology. The training set used to generate data model is partitioned into at least two small sized training sets for data model generation and enrichment process. The blind data set is subjected to the sequence of resulted enriched data models resulting in a high classification percentage.

### TECHNICAL FIELD

The present invention relates to a system and method for classifying data items using data model, specifically classifying data items using multiple number of small sized data models for achieving higher percentage of classification.

### BACKGROUND

A number of classification techniques are known for e.g tag-based item classification, unsupervised classification, supervised classification, decision trees, statistical methods, rule induction, generic algorithms, neural networks etc. For some business enterprises, a large number of products or items need to be organized and categorized in a logical manner. For example, a retailer or a distributor may carry a large number of items in its inventory. These items may then be categorized into a number of groups of related items. Each group may include one or more items and may be represented with a pageset.

Item classification is a very important task for material system standardization. If items are categorized effectively, then one can find items easily and effectively when one uses search and browse. The task of classification gets even critical when the classification of items is used for opportunity assessment for cost optimization. An effective classification can help in identifying the potential areas of cost optimization. This is done by classifying the items using various classification techniques. Item classification is a hierarchical system for grouping products and services according to a logical schema. It establishes a unique identification for every service and product.

A classification problem has an input dataset called the training set that includes a number of entries each having a number of attributes. The objective is to use the training set to build a model of the class label based on the attributes such that the model can be used to classify other data not from the training set.

Consider an example of classification as it applies to a larger problem of Spend Analysis. Spend Analysis consists of analyzing patterns of expenditure and grouping them in different heads. The analysis is beneficial as it highlights the areas of high expenditure and identifies the opportunity for cost optimization. An automated spend analysis system would require grouping (or classifying) of the expense records under different heads (or in different classes) based on certain features of expense records. Some of the features which can be useful in this classification are description of expenditure, name of vendor involved in the transaction, etc.

The complications for classification increase, as the description of expenditure is a free text and there is no standard way of describing expenditure. Gathering intelligence out of the pre-classified data and using it effectively to classify descriptions in unseen data is thus a challenging task. As an example of complications involved in classifying a description, consider a description involving a word “tape” along with some other words. The word “tape” as such does not convey a clue of a single class, as it can be a “magnetic tape”, an “adhesive tape” or even a “measuring tape”. Each of these may fall under different classes as far as Spend Analysis is concerned. Classifying such record accurately is then an important and challenging task.

Another example of a classification problem is that of classifying patients' diagnostic related groups (DRGs) in a hospital. That is determining a hospital patient's final DRG based on the services performed on the patient.

If each service that could be performed on the patient in the hospital is considered an attribute, the number of attributes (dimensions) is large but most attributes have a “not present” value for any particular patient because not all possible services are performed on every patient. Such an example results in a high-dimensional, sparse dataset. A problem exists in that artificial ordering induced on the attributes lowers classification accuracy. That is, if two patients each have the same six services performed, but they are recorded in different orders in their respective files, a classification model would treat the two patients as two different cases, and the two patients may be assigned different DRGs.

U.S. Pat. No. 7,299,215 provides a system and method for measuring the accuracy of a Naive Bayes predictive model and reduced computational expense relative to conventional techniques. A method for measuring accuracy of a Naive Bayes predictive model comprises the steps of receiving a training dataset comprising a plurality of rows of data, building a Naive Bayes predictive model using the training dataset, for each of at least a portion of the plurality of rows of data in the training dataset incrementally untraining the Naive Bayes predictive model using the row of data and determining an accuracy of the incrementally untrained Naive Bayes predictive model, and determining an aggregate accuracy of the Naive Bayes predictive model.

US Patent 2003/0233350 provides a method and system for the classification of electronic catalogs. The method provided has a lot of user-configured features and also provides for constant interaction between the user and the system. The user can provide criteria for the classification of catalogs and subsequently manually check the classified catalogs.

U.S. Pat. No. 6,563,952 provides an apparatus and method for classifying high-dimensional sparse datasets. A raw data training set is flattened by converting it from categorical representation to a boolean representation. The flattened data is then used to build a class model on which new data not in the training set may be classified. In one embodiment, the class model takes the form of a decision tree, and large itemsets and cluster information are used as attributes for classification. In another embodiment, the class model is based on the nearest neighbors of the data to be classified. An advantage of the invention is that, by flattening the data, classification accuracy is increased by eliminating artificial ordering induced on the attributes. Another advantage is that the use of large itemsets and clustering increases classification accuracy.

Catalog type applications are characterized by a large number of relatively simple items. These items may be associated with various attributes used to identify and describe the items. If the items can be sufficiently described and uniquely identified based on their attribute values, then the attributes may be used to classify the items into groups and to further identify the items in each group. Catalog type classification applications are based on few set of attributes with limited number of realizations, as compared to the item classification application, which is based on a set of attributes with potentially very large number of realizations. The task of organizing and classifying the items becomes more challenging as the number of items increases.

The classification pertaining to high-dimensional sparse datasets is that, the complexity required to build a decision tree is high. There are often hundreds, even thousands or more possible attributes for each entry. The large number of attributes directly contributes to a high degree of complexity required to build a decision tree based on each training set.

### SUMMARY AND OBJECTS OF THE INVENTION

The object of the present invention is to provide a system and method for classifying data items using data models.

It is also an object of the present invention to provide a system and method for classifying data items using multiple numbers of small sized data models.

Another object of the present invention is to partition a training set into at least two small sized training sets to generate small sized enriched data model.

Further object of the present invention is to classify the data items belonging to any type of pre-specified taxonomy.

Still further object of the present invention is to achieve a classification percentage that ranges between 75 to 99 percent, in presence of a corresponding quality training set.

Briefly, in accordance with one aspect of the invention, it provides a system and method for classifying data items using data models. The invention performs classification by compilation of randomly classified data items to form a training set, partitioning the training set into at least two smaller size training sets, generating corresponding data models from the smaller size training sets, developing a blind set of unclassified data items and sequentially subjecting the data items of the blind set for classification to the data models. The data items of the training set are pre-classified into one specific classification hierarchy. The training sets are partitioned in range of between 2 to n small sized training sets to generate small sized data models. The classification percentage that is achieved by deploying the said method ranges between 75 to 99 percent. Systems and computer programs that afford such functionality may be provided by the present technique.

In accordance with another aspect of the invention, it also provides a method of data model building by compilation of randomly classified data items to form a training set, partitioning the training set into at least two small sized training sets, creating corresponding classification sets using the small sized training sets, generating a first data model using one of the said small sized training set based on predefined criteria, classifying the data items of one of the said classification set using the first data model according to a predefined classification criteria to form a first classified set, separating data items that are erroneously classified from the first classified set to form a first unclassified set, eliminating the data items from the unclassified set that do not provide any clue for classification, extracting correct classification codes of data items of unclassified set from the corresponding training set and adding them to the next small sized training set to form a second training set, generating a second data model using the second training set based on predefined criteria, classifying the data items of a second classification set using the second data model according to a predefined classification criteria to form a second classified set, separating data items that are erroneously classified from the second classified set to form a second unclassified set and repeating the steps as described above till classification percentage is equal or exceeds a predetermined level. The predefined criteria for generating the data model using the training set is splitting the data item of the training set using predefined delimiters. The predetermined level of classification percentage till which the generation of data models is continued is a stopping criterion for data model enrichment process. Systems and computer programs that afford such functionality may be provided by the present technique.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a flowchart illustrating exemplary method of classifying data items in accordance with aspect of the present technique;

FIG. 2 is a flowchart illustrating a data model building and enrichment method in accordance with aspects of the present technique.

FIG. 3 is a system for classification of data items in accordance with aspects of the present technique;

FIG. 4 is an illustration by way of example depicting the manner in which data is classified using enriched data models and percentage classification in accordance with aspects of the present technique.

FIG. 5 is an illustration of entire process of model enrichment and classification using multiple models.

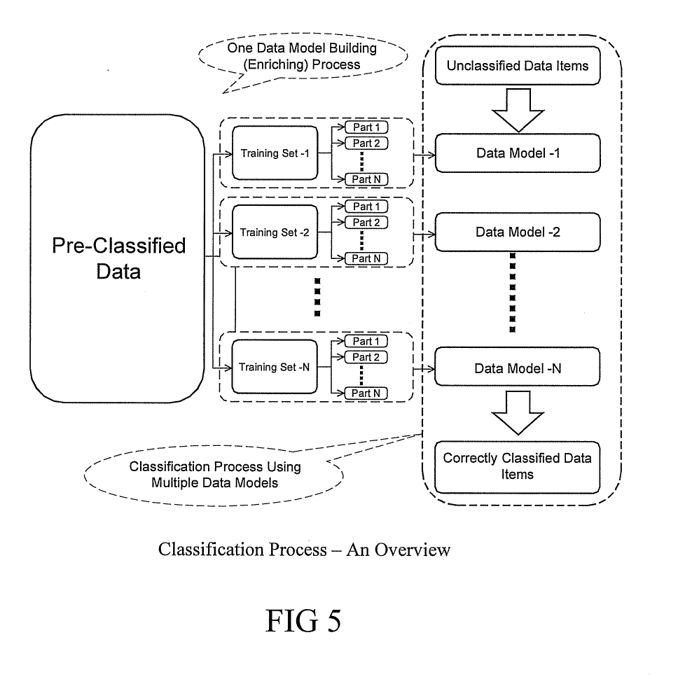

### DETAILED DESCRIPTION OF THE DRAWINGS

The present invention is directed to data item classification and data model building technology. It operates in mainly two stages. In the first stage, a data model is built using an existing set of classified data known as training set. The existing set of classified data is a random collection of pre-classified data items each belonging to a specific classification hierarchy. The training set is used to build a data model and a series of enriched data models are used to classify the blind data items or unclassified data items. The training sets can be partitioned into small size training sets and each small size training set is used to generate each data model. The blind data set having unclassified data items are classified according to predefined classification criteria using multiple enriched data models one by one. The data items are screened using the first enriched data model. The data which is erroneously classified out of the first enriched data model is screened out of second enriched data model in sequence. The process of screening the data items is continued with few more enriched data models. The total items correctly classified out of all enriched data models results in a very high percentage of classification. The present technique of classification can be used for classifying data items belonging to any type of pre-specified taxonomy.

The present invention makes use of the following terminology for the purpose of defining the invention which in no way should be taken as limiting the invention.

Matches: A number associated with each combination of a word and a category in the training set. The number indicates the frequency of the word in the associated category in the training set.

NonMatches: A number associated with each combination of a word and a category in the training set. This number is the compliment of the Matches of the word from the sum of frequency of all words in the corresponding category in the training set.

Words: A set of characters in the description separated by occurrence of an SPACE character or pre-defined delimiters.

UNSPSC: A standard classification taxonomy United Nation Services and Product Standard Code.

Probability: A number associated with a category indicating the chances of an item being classified in this category.

Match Factor The ratio of number of words of an item description matching with a given category and the total number of words in the item description. Note the words appearing in NoiseSet file, if appeared in the description or the class are excluded in match factor calculation. This is one of the classification criteria of item classification accuracy.

NoiseSet File: It is a repository of words that does not provide any clue to classify a given item description. These words are ignored during data model creation as well as classification process.

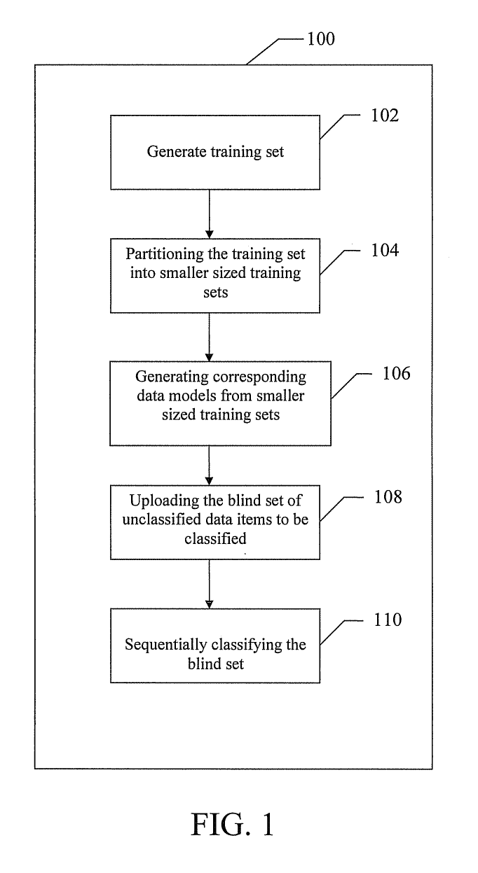

Now Referring to FIG. 1 is a flowchart illustrating exemplary method 100 for classifying data items in accordance with aspects of the present technique. By way of example, the exemplary method is used for classifying the items categorized under United Nations Standard Products and Services Classification (UNSPSC) codes. The UNSPSC code is the coding system to classify both products and services for use throughout the global marketplace. The technique may be used for any taxonomy which are eClass, eOTD, or a client customized taxonomy etc. Taxonomies are usually either country specific or client specific. The taxonomy may be two level, three level, four level or higher depending upon the classification requirement.

The method 100 for classifying data items is now explained by referring to FIG. 1 in accordance with an embodiment of the invention.

At step 102, a training set is generated, which is a random collection of pre-classified data items. These pre-classified data items belong to one specific classification hierarchy of the taxonomy as explained above.

At step 104, the training set is partitioned into at least two smaller size training sets to generate small sized data models that result in higher percentage of classification.

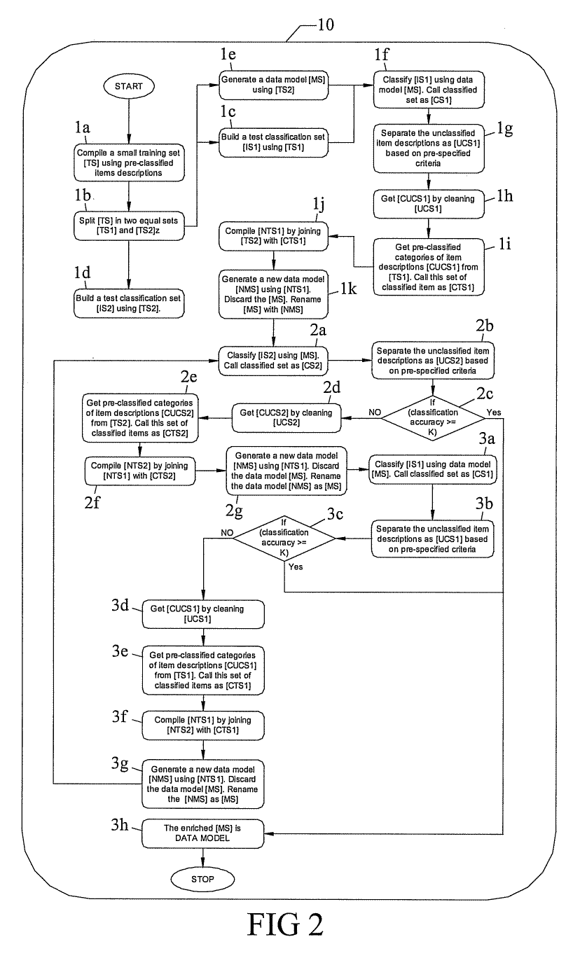

At step 106, corresponding data models are generated from the smaller size training sets. One training set generates one enriched model as explained in FIG. 2. The data model can be built using items of mixed domain and specific domain. There are two types of data models that are customized data models and generic data models. The data models which are built using group of item descriptions from a specific domain are called as customized data models. The data models which are built using group of item descriptions from multiple domains are called as generic data models.

At step 108, a blind set consisting of unclassified data items is provided as an input to the data model generated at step 106 for classification purposes.

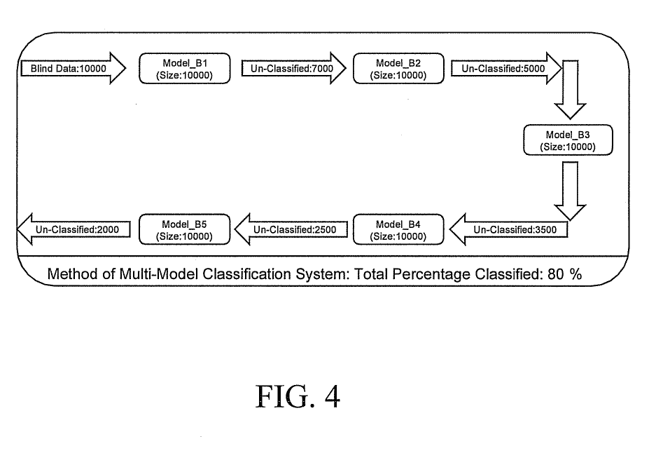

At step 110, the classification of the data items of the blind set is achieved in a sequential manner as explained by way of illustration in FIG. 4. For example if there are two training sets, each generating two corresponding data models, then a blind set consisting of unclassified data items is provided as an input to the first data model. The data items that remain unclassified are given to the second data model which will classify the remaining data items. In the same way, the data items that remain unclassified from the second data model are fed to the other data models in sequence. The blind data items for which the domain is known in advance are classified using the domain specific data models i.e. customized data model first. The remaining unclassified item descriptions are subsequently classified using generic data models. Though there is no specific sequence for using the generic and customized data models. The sequence may vary for a specific case of blind data items. But if the domain of a blind data set is not known in advance then the blind data is classified using only generic data models.

FIG. 2 explains the method of data model building process in accordance with one embodiment of the invention.

As illustrated in the flowchart of FIG. 2, the method 10 includes the generation of training set at step 1a which is a random collection of pre-classified items. The pre-classified data items belong to one specific classification hierarchy of the taxonomy as explained above.

The training set generated at step 1a is partitioned into two or more small sized training sets at step 1b to generate small sized data model. By way of example we assume that the training set is partitioned into two small sized training sets.

At step 1c, corresponding first classification set is generated from first small sized training set.

At step 1d, second classification set is generated from the second small sized training set.

At step 1e, first data model is generated using the second small sized training set based on pre-defined criteria described below. The data model is a set of words or data items that appears in item descriptions. For example, if the item descriptions to be classified belong to UNSPSC taxonomy, it contains the words in combination with the UNSPSC category with which they appear in the item description. The words from the item description in the training set are split using predefined delimiters for e.g. SPACE (a pre-defined criteria). The generation of data model at step 104 is further facilitated using a particular file i.e. “NoiseSet” file. This file is a repository of words which does not convey any clue for item classification. To build NoiseSet file, the words are gathered from the data model, because data model is the repository of words and their frequencies in the descriptions. The words in the data model are scanned to recognize those words which do not convey any clue for item classification and insert in the “NoiseSet” file. The words which provide clue for item classification process are selected and rests are ignored. This is because the words appearing in the data model are the actual words that a user provides in item descriptions. The following rules are followed to construct the NoiseSet file:
a. The word which does convey a clue for item classification should not be included in NoiseSet file, irrespective of whether they are correctly spelled or misspelled, should be included in NoiseSet file.
b. The words which does not convey any clue for item classification, irrespective of whether they are correctly spelled or misspelled, should be included in NoiseSet file.

At step 1f, first classification set is classified using the first data model generated at step 1e to form a first classified set. The Naive Bayes Algorithm is used for classification process. The classification process includes splitting of item descriptions into words and calculation of word frequencies. It requires calculation of the probability of an item description to be classified in a given category. An item description is assigned to the category having highest probability of occurrence.

At step 1g, the data items that remain unclassified or are erroneously classified are separated from the first classified set to form a first unclassified set.

At step 1h, the data items that do not provide any clue for the classification process are eliminated from the first unclassified set.

At step 1i, the correct classification codes are extracted for the data items that are unclassified of the first unclassified set from the first small sized training set to form a new set of classified item descriptions.

At step 1j, the new set of classified item descriptions are added to the second small sized training set that was used to generate first data model. The resultant set obtained is second training set. This is known as model tuning which is a process of improving the training set by correcting it and enriching it. The training set is corrected for unnecessary item descriptions which do not convey any clue for item classification. The addition of more item descriptions which were erroneously classified from an existing data model is called training set enrichment process.

At step 1k, second data model is generated using second training set based on the same criteria as used for generating first data model.

At step 2a, the second classification set is classified using second data model according to predefined classification criteria to generate a second classified set.

At step 2b, the data items that remain unclassified or are erroneously classified are separated from the second classified set to form a second unclassified set.

At step 2c, the classification accuracy is determined. If the accuracy or the percentage exceeds or equals a predetermined level, which is a stopping criterion for data model enrichment process the classification process is stopped else the process goes to step 2d.

At step 2d, the data items that do not provide any clue for classification are eliminated from the second unclassified set.

At step 2e, the correct classification codes are extracted for the data items of the second unclassified set from the second small sized training set to form a new set of classified item descriptions.

At step 2f, the new set of classified item descriptions are added to the second training set that was used to generate second data model. The resultant set obtained is third training set.

At step 2g, third data model is generated using the third training set based on the same criteria as used for generating first and second data models.

At step 3a, the first classification set is again classified using the third data model according to predefined classification criteria to generate a third classified set.

At step 3b, the data items that remain unclassified or are erroneously classified are separated from the third classified set to form a third unclassified set.

At step 3c, the classification accuracy is determined. If the accuracy or the percentage exceeds or equals a predetermined level, which is a stopping criterion for data model enrichment process the classification process is stopped else the process goes to step 3d.

At step 3d, the data items that do not provide any clue for classification are eliminated.

At step 3e, the correct classification codes are extracted for the data items that are unclassified of the third unclassified set from the first small sized training set to form a new set of classified item descriptions.

At step 3f, the new set of classified item descriptions are added to the third training set that was used to generate third data model. The resultant set obtained is fourth training set.

At step 3g, fourth data model is generated using the fourth training set based on the same criteria as used for generating previous data models.

By repeating the steps from 2a the resultant data model is enriched data model. The data model is further enriched using the unclassified item descriptions of the classification steps. The process of enriching requires cleaning the unclassified items and adding them to the previous training set. The process continues from steps 2a until the classification percentage exceeds or is equal to a predetermined level.

Incase, the training set is partitioned into more than two small sized training sets in step 1b, the process of data model enrichment is further continued from step 1f, for every subsequent classification set corresponding to the next partitioned training set.

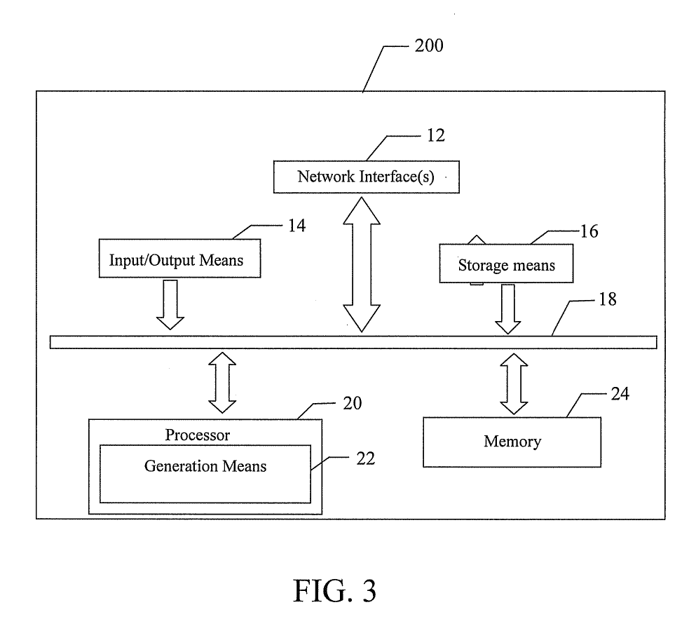

Referring now to FIG. 3, a schematic diagram of an exemplary system 10 for classification of data items is illustrated in accordance with aspects of the present technique. The system 200 includes a network interface 12, input/output means 14, storage means 16, processor 20, memory 24 connected via a data pathway (e.g. buses) 18.

The processor 20 accepts instructions and data from the memory 24 and performs various data processing functions. Processor 20 may be a single processing entity or a plurality of entities comprising multiple computing units and may comprise generation means for generating data models. The memory 24 generally includes a random-access memory (RAM) and a read-only memory (ROM); however, there may be other types of memory such as programmable read-only memory (PROM), erasable programmable read-only memory (EPROM) and electrically erasable programmable read-only memory (EEPROM). Also, the memory preferably contains an operating system, which executes on the processor 20. The operating system performs basic tasks that include recognizing input, sending output to output devices, keeping track of files and directories and controlling various peripheral devices. The information in the memory 20 might be conveyed to a human user through the input/output means 14, the data pathway 18, or in some other suitable manner. The storage means 16 may include hard disks to store program and data necessary for the invention. The storage means may comprise of secondary storage devices such as hard disk, magnetic disk etc. or tertiary storage such as jukeboxes, tape storage etc.

The input/output means 14 may include a keyboard and a mouse that enables a user to enter data and instructions, a display device that enables the user to view the available information and desired results. The system 10 can be connected to one or more networks through one or more network interface 12. The network can be a wired or wireless network and/or can include a data pathway (e.g., data transfer buses).

### Illustration

FIG. 4 explains by way of illustration the method of classifying data items.
1. Split the training set of 50000 item descriptions into five equal training set. The size of the new training sets is 10000. The recommended method of splitting the large set is completely random.
2. Build five different data models using the five equal sizes of training sets.
3. Call these data models as Model_B1, Model_B2, Model_B3, Model_B4, and Model_B5.
4. Classify the same 10000 items descriptions that were used in Method 1. The classification should use the five models in sequence.
5. The first model Model_B1 will classify 3000 items.
6. The remaining 7000 items will be classified using Model_B2. The number of items classified will be 2000.
7. The remaining 5000 items will be classified using Model_B3. The number of items classified will be 1500.
8. The remaining 3500 items will be classified using Model_B4. The number of items classified will be 1000.
9. The remaining 2500 items will be classified using Model_B5. The number of items classified will be 500.
10. The total number of items classified using all the five models results to 8000.
11. The classification percentage achieved is 80%.

The above example depicted that the total classification percentage achieved using only four models is 75%. The total size of the four models is 40000. By using fifth model the classification percentage reaches 80 percent.

The method of generating training set, data model and performing classification will be now explained more clearly by taking an example of classifying data items based on UNSPSC codes with the help of pseudo code.

### EXAMPLE FOR ITEM CLASSIFICATION TRAINING SET AND MODEL SET

The following example is strictly for item classification algorithm illustration. The size of training sets and model sets are very large in practical.

| DESC1 | UNSPSC |
|---|---|
| 11058 HI-TEMP BEARING GREASE | 15121902 |
| aw2 grease | 15121902 |
| 6Y769, HIGH TEMP BEARING | 15121902 |
| GREASE SILICON | |
| 6616-GREASE-ZERK | 15121902 |
| 0000000, ROTOR | 25171705 |
| 9I2872 Rotor 1342529 Hyster | 25171705 |
| 150022509 ROTOR | 25171705 |
| BW D236 ROTORS | 25171705 |

| Words | Category | Matches | NonMatches |
|---|---|---|---|
| 11058 | 15121902 | 1 | 15 |
| HI | 15121902 | 1 | 15 |
| TEMP | 15121902 | 2 | 14 |
| BEARING | 15121902 | 2 | 14 |
| GREASE | 15121902 | 4 | 12 |
| aw2 | 15121902 | 1 | 15 |
| 6Y769 | 15121902 | 1 | 15 |
| HIGH | 15121902 | 1 | 15 |
| SILICON | 15121902 | 1 | 15 |
| 6616 | 15121902 | 1 | 15 |
| ZERK | 15121902 | 1 | 15 |
| 0000000 | 25171705 | 1 | 10 |
| ROTOR | 25171705 | 3 | 8 |
| 912872 | 25171705 | 1 | 10 |
| 1342529 | 25171705 | 1 | 10 |
| Hyster | 25171705 | 1 | 10 |
| 150022509 | 25171705 | 1 | 10 |
| BW | 25171705 | 1 | 10 |
| D236 | 25171705 | 1 | 10 |
| ROTORS | 25171705 | 1 | 10 |

Step A: Generate and Enter Training Set

The training set is a list of classified items.

Step B: Generate Model Set

Start

Note: the column titles of the model set are Words, Category, Matches, and NonMatches

Step 1.a: Determine the frequencies for each combination of a word ‘i’ and a category ‘j’ in the training set. Call it Freq_Word_ij.

Step 1.b: Determine the sum of frequencies Freq_Word_ij of each word of UNSPSC_j. Call it Tot_Freq_UNSPSC_j.

Step 2: Read first item description Item_Desc_1 from the training set
Step a: Name the corresponding UNSPSC as UNSPSC_1
Step b: Read the first word Word_1 of the description Item_Desc_1 and calculate the Matches and NonMatches of Word_1 from the training set
   Step i: Determine the frequency of first word Word_1 of UNSPSC_1. Call it Freq_Word_11. This quantity is Matches for the pair of Word_1 and UNSPSC_1
   Matches=Freq_Word_{—}11
   Step ii: NonMatches for the pair of word Word_1 and category UNSPSC_1 is given by:

NonMatches=Tot_Freq_UNSPSC_{—}1−Matches
Step c: Read next word of the Item_Desc_1
   Step i: Name this word as Word_2
   Step ii: Repeat the steps i to ii of step b

Step 3: Read the next item description Item_Desc_2 from the training set
Step a: IF NOT (The corresponding UNSPSC is UNSPSC_1) THEN name it as UNSPSC_2 and repeat step 2 ELSE UNSPSC_1, repeat step 2 (b), (c)

Step 4: Repeat the step 3 for each of the item descriptions in the training set one by one.

Stop

Step C: Generate Classification Set

Start
Step 1: Calculate probability of first description Desc_1 categorized in first UNSPSC code UNSPSC_1.
   Step a: Calculate priorfor UNSPSC_1: P (UNSPSC_1).
      Step i: This is equal to the ratio of total frequency of category UNSPSC_1 with the total frequency of all categories in the model set.
   Step b: Another parameter to be calculated is the joint probability distribution of group of words in the Desc_1 which is a scaling factor and does not affect the classification process; therefore we ignore the calculation of joint probability distribution parameter.
   Step c: Calculate P (W₁/UNSPSC_1) where W₁ is the first word of the Desc_1.
   IF (The pair of W1 and UNSPSC_1 is found in the model set) THEN Prob_Word_{—}1=[Matches/(Matches+NonMatches)]
   ELSE
      Prob_Word_{—}1=an insignificant nonzero quantity.
   Step d: Repeat the Step ‘c’ for each word of a given description Desc_1
   Step e: Calculate posteriori probability P (First Code/First Description).
      Step i: Multiply the probability of each word of the item description Desc_1 for a given category UNSPSC_1. Call this resulted number as Prob_Word
   Step ii: Multiply the P (UNSPSC_1) with Prob_Word
   Step iii: The resulted number is named as P (UNSPSC_1/Desc_1)
Step 2: Calculate probability of Desc_1 categorized in next UNSPSC code.
   Step a: Repeat the step 1.
Step 3: Sort all the UNSPSC codes in descending order of P (UNSPSC/Desc_1) probabilities.
Step 4: Assign first UNSPSC code (The one associated with highest probability) to the Desc_1. Name this UNSPSC as UNSPSC_Desc_1
Step 5: Calculate Match Factor for the Desc_1.
   Step a: Determine the number of words in the item description Desc_1. Name this parameter as Tot_Words_Desc_1
   Step b: Determine the number of words of Desc_1 matches with the group of words of UNSPSC_Desc_1, Name this parameter as Match_Words_UNSPSC_Desc_1
   Step c: The match factor is the ratio of Match_Words_UNSPSC_Desc_1 with Tot_Words_Desc_1.
   Match Factor=Match_Words UNSPSC Desc_1/Tot_Words Desc_1
Step 6: Repeat step 1, 2, 3 4 and 5 for all subsequent item descriptions.

Stop

The training set consists of two columns item descriptions and UNSPSC code. The data model generation consists of four columns word, category which is UNSPSC code, Matches and NonMatches. The classification set consists of five columns that are item description, UNSPSC code, Probability, Match Factor and S. No. The definition of these columns is explained above.

Having described the embodiments of the invention, it should be apparent to those, skilled in the art that the foregoing is merely illustrative and not limiting, having been presented by way of example only. It will be apparent to those of skill in the appertaining arts that various modifications can be made within the scope of the above invention. Accordingly, the invention is not to be considered limited to the specific examples chosen for the purposes of disclosure, but rather to cover all changes and modifications which do not constitute departures from the permissible scope of the present invention. The invention is therefore not limited by the description contained herein or by the drawings, but only by the claims.

What is claimed is:

1. A method for building data model, the method comprising the steps of:
a. compilation of a random collection of pre-classified data items to form a training set;
b. partitioning the training set into at least two small sized training sets;
c. creating corresponding classification sets using the small sized training sets;
d. generating a first data model using one of the said small sized training set based on predefined criteria;
e. classifying the data items of one of the said classification set using the first data model according to a predefined classification criteria to form a first classified set;
f. separating data items that are erroneously classified from the first classified set to form a first unclassified set;
g. eliminating the data items from the unclassified set that do not provide any clue for classification;
h. extracting correct classification codes of data items of unclassified set from the corresponding training set and adding them to the next small sized training set to form a second training set;
i. generating a second data model using the second training set based on predefined criteria;
j. classifying the data items of a second classification set using the second data model according to a predefined classification criteria to form a second classified set;
k. separating data items that are erroneously classified from the second classified set to form a second unclassified set;
l. repeating the steps g to k till classification percentage is equal or exceeds a predetermined level; and
m. repeating the steps e to l for subsequent small sized training sets and the corresponding classification set till the classification percentage is equal or exceeds a predetermined level.

2. The method of claim 1, wherein the data items of the training set are pre-classified into one specific classification hierarchy.

3. The method of claim 1, wherein the number of small sized training sets ranges between 2 to n.

4. The method of claim 1, wherein the predefined criteria for generating the data model using the training set is splitting the data items of the training set using predefined delimiters.

5. The method of claim 1, wherein the predetermined level of classification percentage is a stopping criterion for data model enrichment process.

6. A method for classifying data items, the method comprising the steps of:
a. compilation of a random collection of pre-classified data items to form a training set;
b. partitioning the training set into at least two smaller size training sets;
c. generating corresponding data models from the smaller size training sets;
d. developing a blind set of unclassified data items; and
e. sequentially subjecting the data items of the blind set for classification to the data models.

7. The method of claim 6, wherein the data items of the training set are pre-classified into one specific classification hierarchy.

8. The method of claim 6, wherein the partitioning of training sets ranges between 2 to n.

9. The method of claim 6, wherein the predetermined level of classification percentage ranges between 75 to 99 percent.

10. A system for building data model, the system comprising:
a. an input unit for entering a set of pre-classified data items;
b. a processor configured to:
i. compilation of a random collection of pre-classified data items to form a training set;
ii. partitioning the training set into at least two small sized training sets;
iii. creating corresponding classification sets using the small sized training sets;
iv. generating a first data model using one of the said small sized training set based on predefined criteria;
v. classifying the data items of one of the said classification set using the first data model according to a predefined classification criteria to form a first classified set;
vi. separating data items that are erroneously classified from the first classified set to form a first unclassified set;
vii. eliminating the data items from the unclassified set that do not provide any clue for classification;
viii. extracting correct classification codes of data items of unclassified set from the corresponding training set and adding them to the next small sized training set to form a second training set;
ix. generating a second data model using the second training set based on predefined criteria;
x. classifying the data items of a second classification set using the second data model according to a predefined classification criteria to form a second classified set;
xi. separating data items that are erroneously classified from the second classified set to form a second unclassified set;
xii. repeating the steps vii to xi till classification percentage is equal or exceeds a predetermined level; and
xiii. repeating the steps v to xii for subsequent small sized training sets and the corresponding classification set till the classification percentage is equal or exceeds a predetermined level.
c. a memory operable to store instructions executable by a processor;
d. means for storing the said data models and classified data items executed by the processor; and
e. an output unit for displaying message of completion of data model creation.

11. The system of claim 10, wherein the data items of the training set are pre-classified into one specific classification hierarchy.

12. The system of claim 10, wherein the number of small sized training sets ranges between 2 to n.

13. The system of claim 10, wherein the predefined criteria for generating the data model using the training set is splitting the data items of the training set using predefined delimiters.

14. The system of claim 10, wherein the predetermined level of classification percentage is a stopping criterion for data model enrichment process.

15. A system for classifying data items, the system comprising:
a. an input unit for entering a blind set of unclassified data items;
b. a processor configured to compile a random collection of pre-classified data items to form a training set, the processor further configured to:
i. partition the training set into at least two smaller size training sets;
ii. generating corresponding data models from the smaller size training sets;
iii. developing a blind set of unclassified data items; and
iv. sequentially subjecting the data items of the blind set for classification to the enriched data models.
c. a memory operable to store instructions executable by a processor;
d. means for storing the said data models and classified data items executed by the processor; and
e. an output unit for displaying the classified data items.

16. The system of claim 15 wherein the data items of the training set are pre-classified into one specific classification hierarchy.

17. The method of claim 15, wherein the partitioning of training sets ranges between 2 to n.

18. The method of claim 15, wherein the predetermined level of classification percentage ranges between 75 to 99 percent.

19. A computer program product for building enriched data model, the computer program product comprising a computer readable storage medium and a computer program instructions recorded on the computer readable medium configured for performing the steps of:
a. compilation of a random collection of pre-classified data items to form a training set;
b. partitioning the training set into at least two small sized training sets;
c. creating corresponding classification sets using the small sized training sets;
d. generating a first data model using one of the said small sized training set based on predefined criteria;
e. classifying the data items of one of the said classification set using the first data model according to a predefined classification criteria to form a first classified set;
f. separating data items that are erroneously classified from the first classified set to form a first unclassified set;
g. eliminating the data items from the unclassified set that do not provide any clue for classification;
h. extracting correct classification codes of data items of unclassified set from the corresponding training set and adding them to the next small sized training set to form a second training set;
i. generating a second enriched data model using the second training set based on predefined criteria;
j. classifying the data items of a second classification set using the second enriched data model according to a predefined classification criteria to form a second classified set;
k. separating data items that are erroneously classified from the second classified set to form a second unclassified set;
l. repeating the steps g to k till classification percentage is equal or exceeds a predetermined level; and
m. repeating the steps e to l for subsequent small sized training sets and the corresponding classification set till the classification percentage is equal or exceeds a predetermined level.

20. The computer program product of claim 19, wherein the data items of the training set are pre-classified into one specific classification hierarchy.

21. The computer program product of claim 19, wherein the number of small sized training sets ranges between 2 to n.

22. The computer program product of claim 19, wherein the predefined criteria for generating the enriched data model using the training set is splitting the data items of the training set using predefined delimiters.

23. The computer program product of claim 19, wherein the predetermined level of classification percentage is a stopping criterion for data model enrichment process.

24. A computer program product for classifying data items, the computer program product comprising a computer readable storage medium and a computer program instructions recorded on the computer readable medium configured for performing the steps of:
i. compilation of a random collection of pre-classified data items to form a training set;
ii. partition the training set into at least two smaller size training sets;
iii. generating corresponding enriched data models from the smaller size training sets;
iv. developing a blind set of unclassified data items; and
v. sequentially subjecting the data items of the blind set for classification to the enriched data models.

25. The computer program product of claim 24, herein the data items of the training set are pre-classified into one specific classification hierarchy.

26. The computer program product of claim 24, wherein the partitioning of training sets ranges between 2 to n.

27. The computer program product of claim 24, wherein the predetermined level of classification percentage ranges between 75 to 99 percent.
